(19) United States
(12) Patent Application Publication
(10) Pub. No.: US 2010/0281025 A1
(43) Pub. Date: Nov. 4, 2010

(54) METHOD AND SYSTEM FOR RECOMMENDATION OF CONTENT ITEMS

(75) Inventors: Dorothea Tsatsou, Thessaloniki (GR); Paul C. Davis, Arlington Heights, IL (US); Symeon Papadopoulos, Thessaloniki (GR); Fotis Menemenis, Thessaloniki (GR); Ben M. Bratu, Versailles (FR); George Kalfas, Thessaloniki (GR); Ioannis Kompatsiaris, Triadi (GR)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 12/434,842

(22) Filed: May 4, 2009

(51) Int. Cl. G06F 17/30

(52) U.S. Cl. 707/733; 707/E17.039; 707/E17.071

(57) ABSTRACT

A method of generating recommendations for content items comprises providing a domain ontology where concepts are characterized by a term vector with terms and associated weights. Associated term sets, each of which comprises a set of terms that characterize a content item, are further provided. A concept set is generated for each associated term set by determining the concepts of the domain ontology that match the terms of the associated term set. In addition, a user profile for a user is provided where the user profile comprises at least some of the concepts of the ontology coupled with preference weights. Recommendations for content items are generated based on the plurality of associated concept sets and the user profile. The invention may allow improved and/or facilitated generation of recommendations from text based characterizing data.

### FIELD OF THE INVENTION

The invention relates to recommendation of content items and in particular, but not exclusively, to selection of content items, such as advertisements, suitable for a specific user profile.

### BACKGROUND OF THE INVENTION

In recent years, the availability and provision of text documents, multimedia, and entertainment content has increased substantially. For example, the number of available television and radio channels has grown considerably and the popularity of the Internet has provided new content distribution means. Also, the Internet has provided the average user with a seemingly endless source of text documents in the forms of web pages, blogs, online text documents etc. In order to facilitate selection of appropriate content for a user, recommendation systems have been developed that seek to automatically identify and recommend content items which suits the user's preferences and characteristics.

It has furthermore become of interest to provide additional associated content that relates to the content which is consumed by a user. Such associated content may for example be advertisements, such as an advertisement inserted in a television program or added to a web page. In order to provide associated content which is of particular interest to the individual user, it is desirable that such content is specifically adapted to the individual user's preference profile and to the specific content that the user is currently accessing. In particular, it has been proposed that advertisements are specifically adapted to the content being consumed and to the content consumption preferences of the individual user. For example, when a user accesses a web page, it is desirable for any associated advertisements to reflect the user's preferences and the characteristics of the specific web page.

Such targeting and personalization can be achieved by selecting content from a content library such that it matches the user's profile. For example, when a user selects a specific content item, such as a webpage or a music clip, on a device, the device may access a local or remote content store to retrieve an associated content item that matches the consumed content item and the user's profile. In order to support such functions, recommender systems have been developed in order to target appropriate content for users e.g. based on their behaviour (e.g. web sites visited, television programs watched, and so on). The content which is targeted can be in various forms, such as advertisements, additional selections the user might be interested in, or a presentation of new services available to the user.

Such recommendation systems are often based on metadata that characterises the content. Such metadata may for example be textual metadata that describes characteristics of the content by a set of terms. The recommender systems often use characterizing data for several purposes. Indeed, the characterizing data for the available content items that the recommender evaluates is evaluated in order to select suitable content items to recommend. In addition, the characterizing data for content items the user consumes is used to determine the user's profile and in particular the individual preferences of the user.

However, in many systems a problem arises as the characterizing data for different content may not be directly comparable. Indeed, for text based characterizing data this is a particular problem as the same meaning may be conveyed by different terms, sometimes the same term may have different meanings etc. Therefore, it is often difficult to provide accurate semantically based recommendations in practical recommender systems.

As an example, a user may consume a content item in the form of a web page comprising a text relating to a specific football club. An automated text analysis may be applied to the web page to extract suitable text based characterizing data, including the name of the football club, the names of some players etc. Another web page may be evaluated by the recommender system as a potential content item to recommend. This web page may discuss exactly the same issues as the web page already consumed. However, it may use different terminology and therefore a text analysis applied to this web page may generate text based characterizing data which is very different than that generated from the consumed web page. For example, the consumed web page may be a formal club web page using the formal names of players and the football club. The potential target web page may however be an informal fan generated web page that uses slang and nicknames for the football club and the player names. Thus, although the two documents are semantically very close, the generated characterizing data may be substantially different thereby making it unlikely that the closely related web pages will be considered as such by the recommender.

It is clear from such a simplistic example, that significant problems occur in more complex systems where a large amount of non-homogenous content is considered both for generating the user profile and for target recommendations. Indeed, in scenarios where a large amount of independently generated content is considered, the problem becomes very significant. For example, when considering web pages, the text content often varies significantly in style, vocabulary etc.

The variations in characterizing data tends to not only result in reduced accuracy of the recommendations but also often results in complex, time consuming and resource consuming implementations. For example, very large data structures with associated high requirements for memory and computational resource are often the result. Therefore, accurate recommendations can often not be provided on resource constrained devices, such as portable media players, mobile phones or set top boxes.

For example recommendation services have been proposed that can take advantage of semantic user profiles in order to provide content recommendation. However, one of the main challenges for such systems is that the characterizing data for the content to recommend (e.g. advertisements) may not directly match that of the content being consumed. Indeed, web pages consumed by the user may use a completely different vocabulary than the advertisements that the recommender is selecting between. As a result a user profile which is based on text analysis of consumed content will not accurately match the characterizing data generated by a text analysis applied to the advertisements.

In order to include such considerations in the recommendation, very complex and resource demanding recommendation systems tend to result. Indeed, most such recommendation services are too complex and resource demanding to be executed by a resource constrained client and must therefore be executed by remote servers thereby resulting in a need for communication, increased latency, undermining user privacy etc.

Hence, an improved approach for generating content item recommendations would be advantageous and in particular a system allowing increased flexibility, improved content item selection, reduced resource usage, improved suitability for resource constrained devices, facilitated implementation, minimal server communication and/or improved performance would be advantageous.

### SUMMARY OF THE INVENTION

According to an aspect of the invention there is provided a method of generating recommendations for content items, the method comprising: providing a domain ontology comprising a plurality of interrelated concepts, each concept of the plurality of interrelated concepts being represented by a term vector comprising at least one term and an associated weight for each term; providing a plurality of associated term sets, each associated term set of the plurality of associated term sets comprising a set of terms characterizing a content item of a group of content items; generating a plurality of associated concept sets for the group of content items by determining for each of at least some of the plurality of associated term sets a set of concepts comprising concepts of the domain ontology matching terms of the associated term set; providing a user profile for a user, the user profile comprising user preference weights associated with at least some concepts of the domain ontology; generating recommendations for at least one content item from the group of content items in response to the plurality of associated concept sets and the user profile.

The invention may in many scenarios and applications allow an improved and/or facilitated recommendation of content items. The inventors have in particular realized that an improved recommendation may be achieved by using a domain ontology wherein each concept is represented by a term vector where each term has at least one associated weight. The approach may in particular allow an improved text based recommendation and may allow an efficient harmonization in systems based on large, varied and non-homogenous content collections. For example, the invention may allow efficient content recommendation in systems wherein content items are characterized by data in the form of term sets. The term sets may use different vocabulary, may be based on different styles etc. The specific domain ontology structure of using term vectors may allow a highly efficient harmonization of different content item term sets by translating them into a common representation using a set of ontology concepts. In addition, the approach may allow harmonization of such term sets with the user profile. The system may for example be particularly useful for systems wherein the user profile is generated based on (translation of) term vector sets characterizing consumed content items.

The invention may e.g. provide highly advantageous recommendation of content items based on automated text analysis of individually and separately generated content items. Typically, efficient recommendation may be achieved for reduced resource consumption. Indeed, the invention may allow recommendation based on relatively limited data structures thereby allowing recommendation with reduced storage and computational requirements. In particular, the invention may in many embodiments allow recommendation in resource constrained devices, such as portable media players, mobile phones and set-top boxes.

According to another aspect of the invention there is provided a system for generating recommendations for content items, the system comprising: a unit for providing a domain ontology comprising a plurality of interrelated concepts, each concept of the plurality of interrelated concepts being represented by a term vector comprising at least one term and an associated weight for each term; a unit for providing a plurality of associated term sets, each associated term set of the plurality of associated term sets comprising a set of terms characterizing a content item of a group of content items; a unit for generating a plurality of associated concept sets for the group of content items by determining for each of at least some of the plurality of associated term sets a set of concepts comprising concepts of the domain ontology matching terms of the associated term set; a unit for providing a user profile for a user, the user profile comprising user preference weights associated with at least some concepts of the domain ontology; and a unit for generating recommendations for at least one content item from the group of content items in response to the plurality of associated concept sets and the user profile.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 is an illustration of an example of elements of a communication system;

FIG. 2 is an illustration of a content device;

FIG. 3 is an illustration of an example of a method of generating recommendations;

FIG. 4 is an illustration of an example of a section of an ontology;

FIG. 5 is an illustration of examples of lexical graphs;

FIG. 6 is an illustration of an example of a method of populating an ontology;

FIG. 7 is an illustration of an example of a method of generating a lexical graph; and

FIG. 8 is an illustration of an example of a determining a populated concept.

### DETAILED DESCRIPTION OF SOME EMBODIMENTS OF THE INVENTION

The following description focuses on embodiments of the invention applicable to selection of content items, such as text documents, web pages, music clips, advertisements etc. However, it will be appreciated that the invention is not limited to such applications but may be applied to many other types of content items.

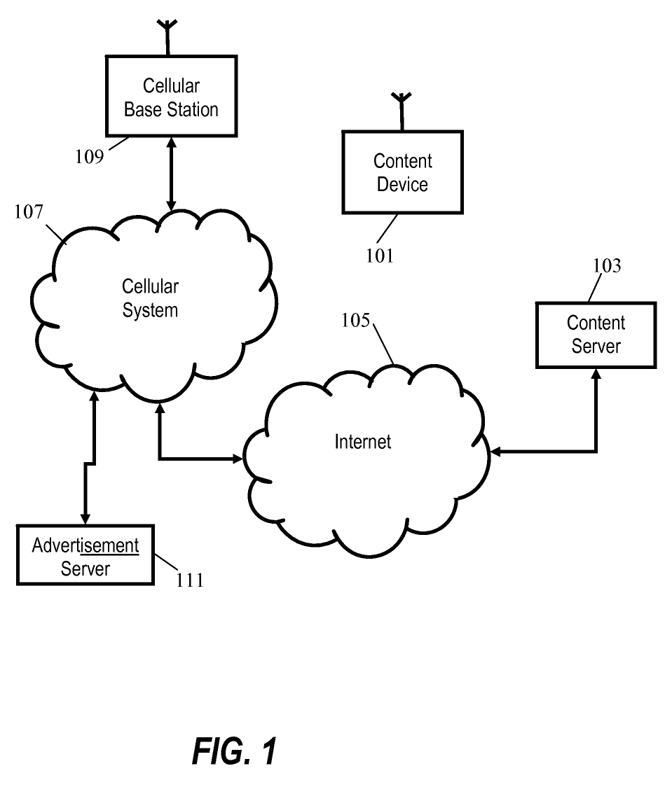

FIG. 1 illustrates a communication system used to distribute content to a content device 101 which is capable of consuming content. In the specific example, the content device 101 is a mobile communication device capable of presenting content to a user including presenting video clips, music clips, text documents and web pages to a user. In other embodiments, the content device 101 may for example be a set-top box, a personal computer or a media player. In the example, the content is provided by a content server 103 coupled to a communication network which in the specific example is the Internet 105. The Internet 105 is coupled to a cellular system 107 which supports the content device 101 via a base station 109. The cellular communication system 107 may for example be a Global System for Mobile communication (GSM) or a Universal Mobile Telecommunication System (UMTS).

In the system, the content device 101 can access the content server 103 to retrieve content items. The content items may for example be music clips, video clips, text documents, web pages, emails, Short Message Service messages etc.

In the system, the content items have associated characterizing data that characterize the content items using text data. For example, the content items may have associated metadata comprising various keywords that characterize the content. Thus, each content item is characterized by a content item term set (or term vector) which characterizes the content item by a set of (typically) a plurality of terms.

In some examples, the content items may themselves comprise text data that may be used to generate the characterizing data. For example, automatic text analysis (e.g. Natural Language Processing and keyword extraction techniques) may be applied to the text of a web page to generate a set of terms that are particularly relevant. Such a content item term set may thus typically include terms such as named entities, frequently occurring terms etc. It will be appreciated that the skilled person will be aware of many different algorithms and approaches for automatic text analysis and generation of characterizing term sets, and that any suitable method may be used without detracting from the invention.

In some embodiments, the content item term sets for the content items may be generated by the content server 103 and may be communicated to the content device 101. Alternatively or additionally, the content device 101 may in some embodiments itself generate or modify the content item term sets characterizing the content items. For example, the content device 101 may perform a term extraction algorithm on a web page consumed by the user in order to generate or enhance a content item term set for the web page.

It will be appreciated that although FIG. 1 for brevity and clarity illustrates only a single content server 103, the system may include a large number of content servers from which the content device 101 can be provided with content items. For example, during web page surfing, the individual web pages may be provided from different servers. Indeed, the content server 103 may be considered representative of all content providers that the content device 101 can access, and may specifically be considered representative of all content providers of the Internet.

In the example, the content device 101 may also receive content items from an advertisement server 111. In the example, the advertisement server 111 is coupled to the cellular communication system 107 and is operated by the cellular network operator which is independent of any operator of the content server 103. The content items provided by the advertisement server 111 are not intended to be individually selected by the user of the content device 101 but are rather intended to be automatically associated with user selected content items from the content server 103. The advertisements are thus intended to be automatically presented by the content device 101 without any specific user selection. The associated content items are in the example selected by the content device 101 so that they match the profile of the user based on the content consumed by the user.

Thus, based on the user behavior when consuming content from the content server 103, the content device 101 is arranged to evaluate and recommend content items (advertisements) from the advertisement server 111. It will be appreciated that in other embodiments, other types of content items may be recommended and that for example the content device 101 may be arranged to recommend other content items provided by the content server 103 based on the user profile when selecting content items from the content server 103. For example, the content device 101 may be arranged to recommend web pages to a user based on the user's consumption and access of other web pages.

In the example, the advertisements are also associated with text based characterizing data. The characterizing data may for example be text based metadata characterizing the content item. The metadata may be generated by the advertisement server 111 by an automated text analysis. For example, a keyword extraction process can be applied to text based content, such as hyperlinked pages in the advertisement itself. This may provide additional information that can be used by the content device 101 when matching advertisements and user selected content. Online advertisements often hyperlink to a web page that enables the user to obtain more information or make a purchase, and this web page will accordingly typically comprise text useful for characterizing the advertisement.

Hence, the advertisement server 111 can provide a number of advertisements that can be downloaded to the content device 101. The advertisement server 111 may furthermore download text based characterizing data for the advertisements to the content device 101. Specifically, for each advertisement, an associated term set (or term vector) may be downloaded to the content device 101. The content device 101 thus has characterizing data in the form of term sets or vectors for both the user selectable content from the content server 103 and the advertisements from the advertisement server 111. The content device 101 accordingly uses these term sets to derive a set of characterizing concepts which are used to recommend (select) one or more advertisements. The recommended advertisements can then be requested from the advertisement server 111 and presented to the user.

It will be appreciated that a recommendation of content items does not necessarily include a recommendation of specific content items to a user but may include any selection or identification of suitable content items. In particular, a recommendation operation may generate recommended content for other functional entities of the content device 101, such as e.g. a processor arranged to automatically download and present advertisements to the user.

In the system of FIG. 1, advertisements provided by a cellular network operator can automatically be selected by the content device 101 to match a user profile that has been determined from a user selection of content being provided from content sources that are completely independent of the cellular network operator and the cellular system itself. Thus, in the specific example, the system considers two different groups of content item, namely the user selectable content items from the content server 103 and the advertisements from the advertisement server 111. In the example, the recommendation is a selection of one or more content items from the second group based on the (previous) user selections of content items from the first group. However, it will be appreciated that in many other embodiments, no such differentiation is included and that the group of content items from which the user profile may be learned (and thus from which the user can select content) may be the same as the group from which content items can be recommended.

It will also be appreciated that whereas the example describes a scenario wherein term sets characterizing the group of content items that can be recommended (the advertisements) are generated externally (at the advertisement server 111 ) and downloaded to the content device 101, the content device 101 may in other embodiments itself generate such characterizing data, e.g. by a local text analysis and keyword extraction operation.

The use of text based characterizing data and in particular characterization of content items by term vectors allow for a highly efficient recommendation while maintaining a low resource requirement. Specifically, the communication resource requirements for the downloading, the storage requirements for storing, and the computational resource requirements for processing such term vectors can be maintained at relatively low levels. Thus, an efficient and low resource requirement operation can be achieved enabling the implementation of the recommendation algorithm in resource constrained devices.

However, a significant problem for such text based recommendation systems is that text based descriptions and characterizations provide a high degree of variability and tend to not be homogenous. In particular, term vector sets generated from automated text analysis may vary substantially even for content items that are closely related. Such difficulties inherently result from the enormous flexibility and variability of human language. For example, the same words may mean different things in different contexts, different terms may have the same meaning, slang and colloquial language may differ substantially from formal language etc. Therefore, in many text based systems, the accuracy of the text based recommendation tends to be suboptimal. Furthermore, in order to address such problems, some recommendation algorithms may attempt to take into account special considerations. For example, when considering a content item, the recommendation algorithm may access an online synonym dictionary to find alternatives for the terms of the term vector of the content item. However, such approaches tend to be very resource demanding and result in both high computational, communication and memory resource requirements.

In the system of FIG. 1, a highly efficient approach is employed wherein a harmonization of characterizing term vectors is achieved through the use of an ontology. Indeed, a novel ontology approach is used wherein each concept is represented by a term vector that comprises at least one term and an associated weight for each term. The term sets for the content items to recommend are translated into concept sets based on the terms of the term sets as well as the terms in the term vectors. The specific ontology structure of having term vectors for each concept provides a very accurate and flexible translation and allows a high degree of accuracy by e.g. allowing uncertainty and degrees of correlation to be reflected and taken into account in the translation.

In the example, the translation of term sets for the content items into the concept sets are performed in the content device 101. However, in other embodiments, such a translation may be performed elsewhere, such as e.g. in the advertisement server 111. Thus, in some embodiments, the advertisement may translate characterizing data for the content items that can be recommended into concepts sets that characterize the content items. Thus, in some embodiments, the content item 101 may receive characterizing data which is already in the form of a concept set.

Furthermore, the user profile used by the content device 101 is also arranged and structured in accordance with the domain ontology. Specifically, the user profile comprises user preference weights for at least some concepts of the domain ontology. Thus, at least some concepts are coupled with user preference weights. Furthermore, the concepts comprising the user profile may or may not structured in one or more rules, based on the basic ontology.

The user profile may for example be generated by applying the same translation operation to term sets of the content items that are being consumed. These can be used to determine one or more concepts to which the consumed content relates. Thus, the corresponding concept of the user profile can then be updated to reflect the user consuming the content.

A common reference frame is provided for all content items thereby allowing an improved recommendation to be performed. The recommendation may indeed not only require reduced resources but may also result in improved accuracy. Thus, the domain ontology may be seen as an “Interlingua” which allows all the different term sets to be compared and correlated despite them representing and using very different terminology, vocabularies and style, while containing sufficient information to significantly improve the relevance of automatically selected advertisements. Furthermore, the specific term and weight based representation of concepts in the domain ontology allows a highly efficient and accurate automated translation into the interlingua represented by the domain ontology.

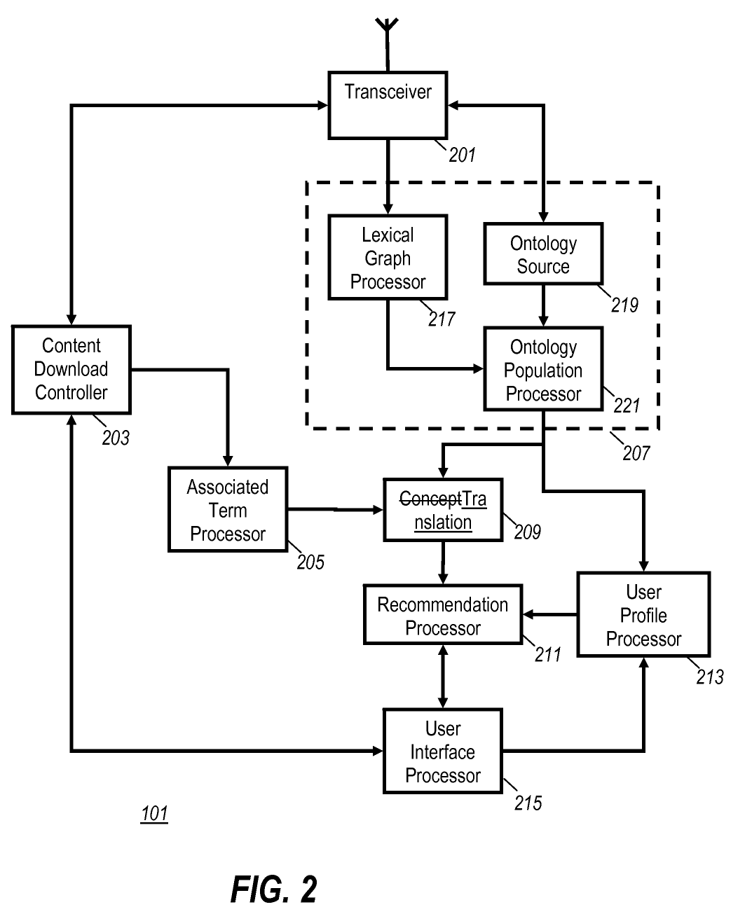

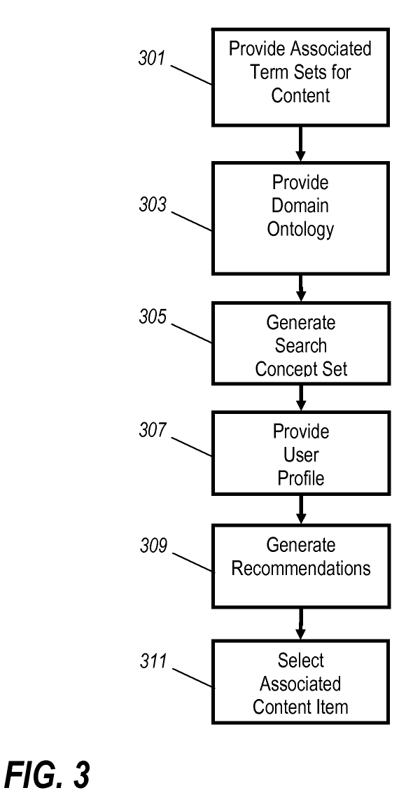

FIG. 2 illustrates an example of a content device 101 in accordance with some embodiments of the invention and FIG. 3 illustrates a method of operation for the content device 101 of FIG. 2. The content device 101 comprises a transceiver 201 which is capable of communicating with the base station 109 over the air interface of the cellular communication system 107. The transceiver 201 is specifically capable of communicating with the content server 103 and the advertisement server 111 via the cellular communication system.

The transceiver 201 is coupled to a content download controller 203 which is capable of communicating with the content server 103 and the advertisement server 111 to retrieve content items (such as web pages, music etc from the content server 103 and advertisements from the advertisement server 111). The content download controller 203 is furthermore arranged to receive characterizing data for the content items from the advertisement server 111 and the content server 103.

The content download controller 203 is coupled to an associated term processor 205 which is arranged to execute step 301 wherein the associated term processor 205 downloads characterizing data for the content items that the recommendation may select between. In the example, this data is downloaded from the advertisement server 111. Thus, the associated term processor 205 controls the content download controller 203 to retrieve associated term sets for the available advertisements where each associated term set comprises a set of terms that characterizes one of the available content items (advertisements).

The content device 101 furthermore comprises an ontology processor 207 which is arranged to provide a domain ontology. An ontology may be used to define how different data objects should be represented. Thus, an ontology is a data model that represents a set of interrelated concepts (or classes) within a domain and the relationships between those concepts. The concepts have associated properties (or attributes) that define characteristics associated with the concept.

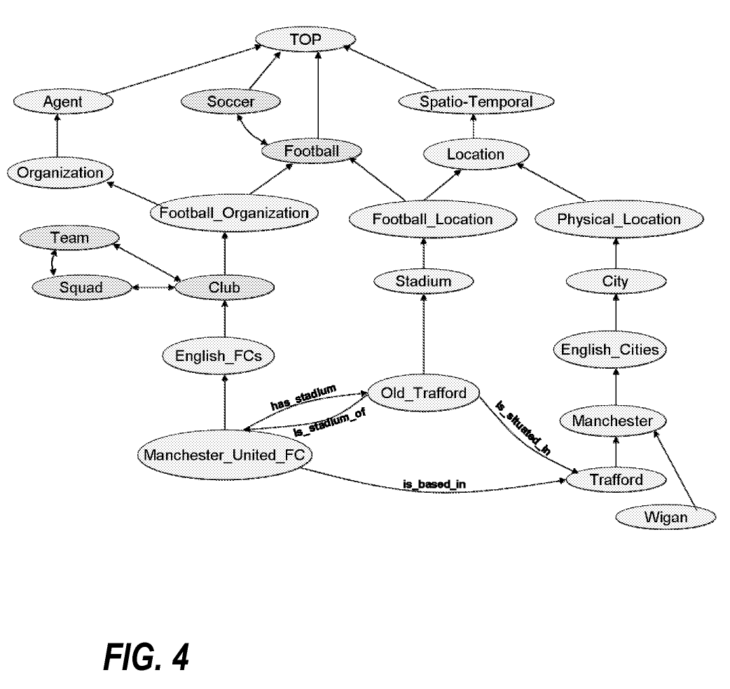

An ontology generally comprises a hierarchical arrangement of concepts connected by heritage links. A child concept corresponds to a further refinement of a parent concept and can specify further properties that only relate to a subset of the parent concept. An example of elements of an ontology representing the domain Football (soccer) is illustrated in FIG. 4. It will be appreciated that practical ontologies are typically much larger than the example of FIG. 4. The ontology provides a definition for how different concepts can be used and interrelate in characterizing content items relating to the Football domain.

An ontology can be seen as a conceptualization of a domain into a human-understandable, but machine-readable format consisting of entities, attributes, relationships and axioms. Ontologies can be based on taxonomies which attempt to classify a virtual or a concrete entity in a hierarchy of associated concepts. As another example, domain ontologies typically attempt to formalize the main concepts of a domain and are typically relatively flat. Domain ontologies tend not to attempt to classify individual instances but rather to represent the links/relations between different domain concepts.

An ontology may often be generated based on a manual design by one or more experts. However, in some scenarios the ontology may be partly or fully automatically generated. As will be described later, the ontology is in the specific example generated by automatically populating an expert generated basic ontology based on a lexical graph. Thus, in the example an expert or group of experts may manually generate an initial basic ontology. This basic ontology is then further enhanced by being automatically populated using one or more lexical graphs. In some scenarios, the generation of the initial basic ontology may involve a partial or fully automated process, for example based on an automated analysis of training material.

It will be appreciated that populating a concept describes the means by which an ontology concept is terminologically expanded by a set of characterizing terms for the concept, collected in a single term vector and coupled with associating weights that represent the association value of the term to the concept.

In the system, a specific ontology approach is used wherein the concepts of the ontology are described by a vector (set) of terms that have associated weights. Thus, rather than merely having a fixed characterization of each concept, the ontology (or ontologies) that are used in the content device 101 are represented by a term vector which contains one or more terms as well as a weight for each term. The weight for a term is indicative of the probability of that term being relevant for characterizing the first concept. Thus, the weight indicates how closely related the term is to the concept. The weight may for example indicate not only how closely the term fits the concept but may also indicate how unique the term is in describing the concept.

For example, for a concept corresponding to “Manchester United Football Club” the term “MUFC”, “Manchester United” and “United” may all be considered relevant and included in the term vector. However, the term “Manchester United” will be given a higher weight than “MUFC” to indicate that it is more widely used and/or to indicate that it is less likely to relate to a different club (such as Marlborough United Football Club). Similarly, a relatively low weight may be given to the term “United” as this may be used for a large number of clubs and is therefore less descriptive of “Manchester United Football Club”.

It will be appreciated that in some embodiments, the entire domain ontology including terms and weights may be manually defined and the ontology processor 207 may e.g. download such a suitably defined ontology from an external source.

The ontology processor 207 thus performs step 303 wherein a domain ontology is provided. The associated term processor 205 and the ontology processor 207 are coupled to a translation processor 209 which receives the associated term sets from the associated term processor 205 and the ontology from the ontology processor 207.

The translation processor 209 executes step 305 wherein each of the term sets from the associated term processor 205 are translated into an associated concept set. Specifically, for at least one, but typically all, of the terms of a term vector describing a content item, the translation processor 209 identifies one (or more) matching concepts in the ontology and includes the concept(s) in a concept set for the content item. Thus, the vocabulary and terminology that happen to be used for the specific content item is translated into a generic and common vocabulary and terminology.

The matching of a term of a term set to a concept of the ontology is based on the term vectors. Specifically, the term vector may include a range of terms including various variants of the same term. The translation processor 209 may first identify concepts that have a term vector comprising a term matching the term of the term set. The concept may then be included based on the weight of the term. For example, an initial concept set comprising all concepts that have term vectors including a term from the term set may be generated. The candidate concept set may then be pruned to include only the highest weighted N concepts. As another example, only concepts for which the weight of the matching term is above a threshold may be included.

The use of the term vector and weight representation of the ontology concepts to match the terms provide for a very efficient and accurate translation. Indeed, the ontology structure allows the same concept to be matched to characterizing text that is based on very different styles and vocabularies. For example, a concept corresponding to a football club may be defined by a term vector comprising both the official names, abbreviated names, nick names and even derogatory names (e.g. used by fans of other clubs) of that club. Accordingly, content items using different references (and therefore not having similar keywords) will all be matched to the same concept.

It will be appreciated that any suitable match criterion for matching terms may be used and that for example this may include processing the term prior to a matching (e.g. to convert all terms to singular, using only the stem of a word etc). Thus, in step 305 the translation processor 209 accordingly generates associated concept sets and annotation for the content items that can be recommended. These associated concept sets are fed to a recommendation processor 211 which is further coupled to a user profile processor 213. The user profile processor 213 performs step 307 wherein a user profile is provided to the recommendation processor 211. The user profile is furthermore structured in accordance with the domain ontology and specifically it comprises preference weights for some or all of the concepts of the ontology. For example, the user profile may comprise a weight that indicates a high preference for one football club, low preference for another etc.

The recommendation processor 211 then proceeds to perform step 309 and generate recommendations based on the concept sets and user profile. E.g. as a very simple example, the preference weights for all concepts included in the concept set for one content item may be accumulated to generate a user preference for the content item. The recommendation processor 211 may then proceed to recommend the content items that have the highest accumulated preference values, e.g. ranked in order of preference value. Thus, not only is the characterizing data for the possible candidates harmonized by a translation into a generic representation defined by a term vector populated ontology, but the user profile is also provided in accordance with this representation thereby allowing a very efficient, yet low resource demanding recommendation to be performed. Indeed, such recommendation may typically be possible even on severely resource restricted devices.

In the example, the generated recommendations are fed to a user interface processor 215 which can select one or more of the generated recommendations to be presented to the user. The user interface processor 215 may for example request that the recommended content items are downloaded. For example, the user interface processor 215 may control the content download controller 203 to download the recommended advertisements from the advertisement server 111. The user interface processor 215 may then proceed to present the advertisements to the user.

In many embodiments, the generated recommendations may further be ranked. For example, the content item found to have the highest preference weight may be listed first, followed by the content item of the next highest preference weight etc. Indeed, the described approach allows a particularly efficient recommendation approach for generating ranked recommendations. In the example, the user interface processor 215 may also receive content item selections from the user for content from the content server 103. In response, the user interface processor 215 requests the content download controller 203 to access the content server 103 in order to retrieve the selected content and a content item term set that characterizes the selected content item.

For example, if a web page is selected by the user, the web page may be downloaded together with text based characterizing text, such as keywords etc. It will be appreciated that in some embodiments, the content device 101 may itself generate the content item term set, e.g. by performing a text analysis including a keyword extraction on the received content item.

In the system, the user profile processor 103 continuously monitors the user behavior and updates the user profile based on the characterizing data of the consumed content. For example, if a user repeatedly requests a specific content item, stores a content item or spends a long time accessing a content item, it is considered highly likely that the user has a preference for that content item. However, if the user quickly deletes, discards, or rejects a content item, it is considered highly likely that the user does not have a preference for that content item.

Thus, whenever the user performs a content item operation, this is registered by the user profile processor 213. It then retrieves the content item term set for that content item and seeks to match it to one or more concepts of the domain ontology, for example using the same approach and match criteria that are used by the translation processor 209. Specifically, the user profile processor 213 proceeds to introduce new or identify concepts of the user profile for which a term vector comprises at least one term that matches at least one of the terms characterizing the content item being consumed.

The preference weights for these concepts are then updated. For example, for a stored content item, the preference weight is increased by a certain amount for all matching concepts to indicate that the user operation is indicative of these concepts being of preference to the user. Conversely, for a quickly deleted content item, the preference weight may be reduced by a given amount to reflect that this is likely to be indicative of a low user preference value for the content. It will be appreciated that in some embodiments, a rejected content item might increase the preference weight of a separate representation of the user's disinterests. The amount that the preference weight is respectively increased or decreased may depend on the weight of the term(s) of the term vector for the concept that matches the characterizing data of the consumed content. E.g. for a relatively low relevance of a matching term to a concept, only a small change is introduced whereas a larger update is introduced when a very high relevance is reflected by the term vector weight.

Thus, the system may not only harmonize text based characterizing data for content items to be recommended but may also harmonize this with text based characterizing data for consumed content items. The approach may allow a low complexity and low resource demanding approach for allowing an accurate user preference profile to be generated based on diverse and varied text based characterizing data for consumed content. In some embodiments, the approach may not only be used to generate and update the user profile but may additionally or alternatively be used to modify and adapt the domain ontology itself. For example, if an often selected content item is characterized by terms that match a plurality of the terms in the term vector for a given concept, it is likely that this is due to these terms being closely related to the concept. Accordingly, the content device 101 may proceed to increase the weights for these terms in the term vector for the concept.

In many typical embodiments, the recommendation processor 211 may apply a reasoning algorithm when generating the recommendations. This reasoning algorithm can specifically be a rule based algorithm wherein a potentially large number of rules are defined to reflect various desired characteristics, interrelations between parameters, etc. For example, rules may include a requirement that when an argument “A” is valid then argument “B” is invalid. The rules may specifically be represented and defined in a standardized format and may e.g. be represented as logical relations, e.g. using formal knowledge representation languages such as Description Logic.

In the specific example, the rule based reasoning algorithm is a fuzzy logic rule based reasoning algorithm. Thus, some or all of the rules are not generated as simple binary rules that may be met or not met but rather fuzzy rules that define more flexible relations may be used. For example, a fuzzy reasoning algorithm may not only determine whether a criterion is met or not but rather may determine the degree to which the criterion has been met. This approach is highly advantageous as it allows recommendations to be ranked according to the matching degree.

Using such advanced reasoning algorithms typically results in much more accurate recommendations and the specific approach of using a term vector populated ontology to provide the data on which to perform the reasoning allows for a highly effective reasoning operation. In particular, it allows statistical characterizing data to be formally represented and incorporated in the reasoning algorithm to deduce a conclusion. Furthermore, the light-weight data used allows the reasoning to be performed on low complexity devices in many embodiments.

In the system of FIG.1 the domain ontology is generated from a basic ontology that is enhanced to include supplementing terms in the term vector. The basic ontology may in some embodiments be generated partially or fully automatically. However, in the specific example, the basic ontology is manually generated by one or more experts to contain a suitable set of concepts and interrelations between the concepts. The concepts may each be defined by a term vector containing one or more terms with a maximum weight reflecting that the term is closely related to the concept. The basic ontology is then expanded to include supplementing domain terms. This expansion is based on data in one or more lexical graphs that have nodes which are terms (such as keywords) and edges (links between nodes) that have values representing the strength of association between the nodes linked by the edge.

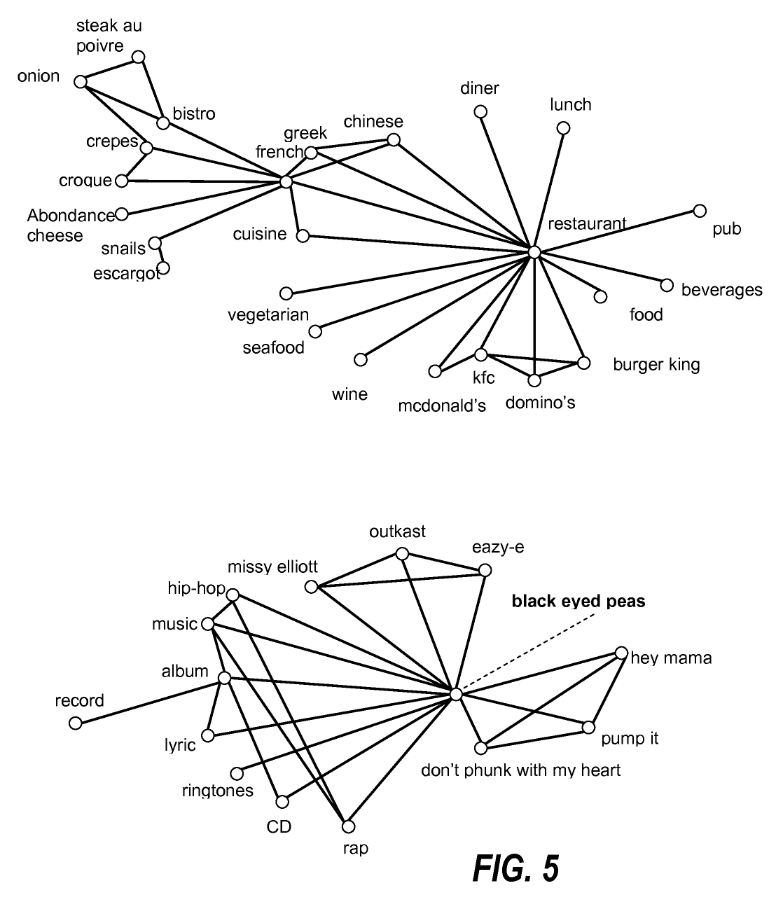

A lexical graph is a data structure that has the form of a connected network of nodes corresponding to terms (each term comprising one or more words). Two (simplified) examples of (sections of) lexical graphs are shown in FIG. 5 (with the first graph corresponding to the topic of eating out and the second graph corresponding to the topic of the music group “Black Eyed Peas”). In the first example of FIG. 5, the nodes “lunch” and “restaurant” are e.g. connected by an edge (represented by a line) as are “pub” and “restaurant”. However, no edge exists between “lunch” and “pub”. The edge (line) between nodes, e.g. “lunch” and “restaurant”, indicates that these terms are considered to be closely related (for example they are often found together in text documents). The edge will also typically be characterized by one or more values that indicate how closely related the two connected terms, e.g. “lunch” and “restaurant”, are considered to be.

In the example, a lexical graph is provided to the content device 101 for each of a number of topics by e.g. the advertisement server 111 or the content server 103. In the example, the ontology processor 207 comprises a lexical graph processor 217 that receives the lexical graphs via the transceiver 217. Similarly, the ontology processor 207 comprises an ontology source 219 which receives the basic domain ontology. The lexical graph processor 217 and ontology source 219 are coupled to an ontology expansion processor 221 which receives the lexical graph(s) and domain ontology(ies) and which then proceeds to expand the term vectors of the domain ontology(ies) based on the lexical graph(s).

It will be appreciated that whereas the specific example focuses on an embodiment wherein the domain expansion is performed in the content device 101, it may in many other embodiments be performed remotely such as in the advertisement server 111, the content server 103 or in a separate server. In such a case, the lexical graphs need not be conveyed to the content device, but rather be processed and stored offline in a separate server, while only the populated ontologies need to be transmitted to the content device.

As will be described later, each lexical graph may e.g. be progressively built up by processing a suitable training set of text documents (either offline or online). Each training set will typically be a corpus, i.e. a complete or comprehensive collection of a specified type, such as e.g. text documents relating to a specific topic. The co-occurrences of terms within these corpora are exploited to build a connected network of terms. The graph nodes constitute a representation for the text terms and the graph edges express the relation (in the sense of co-occurrence) among terms in the graph.

In the specific example, the attributes stored for each node of a lexical graph are: the lemma of the term (a string value), the term frequency in the training documents (a numeric value reflecting how often the term occurs in each document), the document frequency of the term in the training set (a numeric value reflecting the number of text documents of the training set in which the term is present), and the term type (e.g. whether the term is a noun, a named entity (i.e. person, location, organization, etc) or an adjective). Each edge of the graph connects two nodes/terms and indicates that these terms co-occur in a suitable textual relationship in the training set (e.g. dependent on the type of the terms, whether they occur in the same sentence or in the same documents). The edge may have an edge value reflecting how closely linked or associated the terms are considered to be. For example, an edge value may be indicative of the number of co-occurrences of the terms (e.g. in a sentence or in a document).

The lexical graphs may be used to improve the accuracy of term vector characterization of the topic and/or the matching between concepts and the term sets from the different content items. For example, if the original term vector for a concept includes a formal name of a football club, the lexical graph based expansion may result in the automatic inclusion of an additional term corresponding to the nick name of the football club. Also, the lexical graphs provide compact representations of term configurations (i.e. terms and associations among them) for a specific topic or domain. Accordingly, the graphs may be communicated and processed with relatively low resource usage and thus the approach is highly advantageous for resource constrained devices and for resource constrained communication systems.

It is appreciated that in the case of lexical graphs being processed and stored on a separate server the approach's advantages extend to effectively storing and managing large data for multiple domains. Indeed, a substantial benefit of the approach is that the lexical graphs are sufficiently compact to be transmitted across constrained resource networks, such as cellular communication systems, while containing sufficient information to significantly improve the relevance of automatically selected advertisements.

It is appreciated that in embodiments where the lexical graphs are used remotely to populate an ontology and even bigger improvement may often be achieved. Indeed, in such embodiments the enrichment of the ontology with characterizing data from a lexical graph can be achieved while only requiring only storage and transmission of the populated ontology to constrained resource devices.

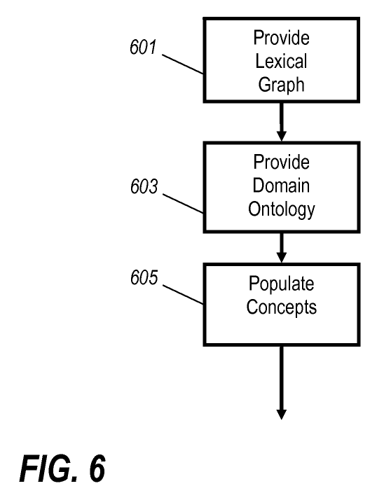

In the system, the ontology population processor 221 accordingly performs the method illustrated in FIG. 6. Initially, in step 601, the lexical graph processor 217 provides one or more lexical graphs. It will be appreciated that if the set of lexical graphs includes more than one graph, one (or potentially more) of the available lexical graphs may be selected. Then, in step 603, the ontology source 219 provides one or more ontologies for each domain to the Ontology Population Processor 221. The ontologies may be determined automatically or manually. At step 605, the Ontology Population Processor 221 uses the selected lexical graphs for the topic to populate the ontology with a term vector for each concept. If the system uses a plurality of ontologies, the specific domain ontology may be automatically selected. For example, a topic for the current recommendation may be determined and the corresponding ontology may be selected.

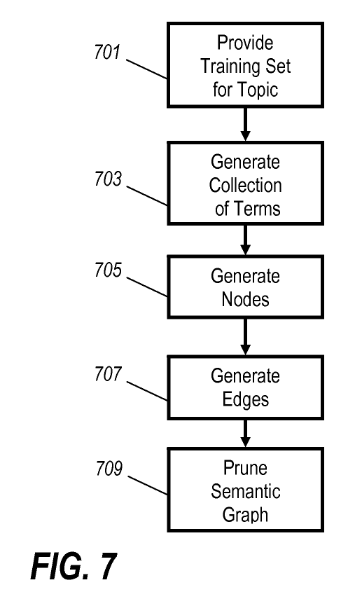

In the specific system, initial lexical graphs for a plurality of topics are generated by the advertisement server 111 and communicated to the content device 101. The method used by the advertisement server 111 to generate a lexical graph is illustrated in FIG. 7. The method initiates in step 701 wherein a set of training content items is provided. The training content items may specifically be a set of text documents that are known to be associated with the specific topic/domain for which the lexical graph is generated. The set of training content items may for example be manually collected text documents (such as web pages). As another example, the set of training content items may be generated as web pages that are found using a specific search criterion relevant for the specific topic.

Step 701 is followed by step 703 wherein a set of terms is generated. Specifically, the advertisement server 111 may extract relevant words from the text documents. As a specific example, a training set comprising web documents may be processed using parsing and Natural Language Processing as will be known to the skilled person. The result can be a set of text segments (a web document may consist of more than one text segment depending on its structure), where each text segment consists of a set of sentences and associated information indicating e.g. the type of the words (noun, adverb, named entity etc). The advertisement server 111 may then extract the terms (and specifically the words) in these text segments. Thus, in step 703, a collection of terms is generated which comprises terms that are extracted from the training content items.

It will be appreciated that in some embodiments, the training content items are not necessarily text documents. For example, the training content items may be video clips that have associated text based metadata and the set of terms generated in step 703 may correspond to terms extracted from the metadata.

Step 703 is followed by step 705 wherein the advertisement server 111 proceeds to generate nodes for the lexical graph. Each of the nodes will correspond to a term of the collection of terms generated in step 703. In the example, a node is generated in step 705 for each term in the collection of terms. This may result in a large lexical graph which in the example will be pruned later. However, it will be appreciated that in some embodiments, nodes may only be generated from a subset of the terms, for example by integrating the node generation and the later described pruning in the same step (i.e. step 705 may also comprise step 709 of pruning the lexical graph as will be described later).

In the specific example, the advertisement server 111 generates a node for each noun, named entity, and adjective accompanying a noun. Furthermore, a node value is generated which includes: the lemma of the term (a string value), the term frequency in the training documents (a numeric value), the document frequency of the term in the training set (a numeric value), and the term type (e.g. whether the term is a noun, a named entity or an adjective). For a term for which a node has already been created, the node value is updated (specifically the term frequency and document frequency may be modified).

Step 705 is followed by step 707 wherein edges are generated for the lexical graph. The edges are generated based on co-occurrences of the terms in the training set. Furthermore, for each generated edge connecting two nodes, an edge value is calculated. The edge value is indicative of the strength of the association between the two terms corresponding to the two nodes. Specifically, the edge value is calculated to be indicative of a co-occurrence frequency for the terms of the two nodes.

In particular, an edge is created:
For all co-occurrences in a sentence between two nouns or between a noun and a named entity.
For all co-occurrences between a noun and an adjacent adjective.
For all co-occurrences between two named entities in a training document.
Furthermore, the edge value is determined as a composite value that stores the number of each of these co-occurrences.

Although the resulting graph may in some embodiments be used directly, the exemplary method of FIG. 7 further includes step 709 wherein the graph is further pruned. This may in many scenarios result in improved recommendation. Indeed, for large lexical graphs, more imprecise results may result as a large graph with many terms and connections will typically represent a substantial degree of “linguistic” noise. Furthermore, the communication resource requirement, as well as the memory and processing resource requirements for the content device 101, may be substantially reduced by reducing the size of the lexical graphs.

Thus, in the example, step 707 is followed by step 709 wherein a number of the nodes generated in step 705 are removed from the graph together with the associated edges. Specifically, the advertisement server 111 may remove a node if the determined term frequency value for the term of the node is below a given threshold or if the document frequency value for the term of the node is below a given threshold. Lower thresholds for both term frequency values and document frequency values may be determined based on the statistics for these values in the graph (e.g. all nodes having a term frequency value below the average term frequency value may be removed and all nodes having a document frequency value below the 50% of the average document frequency may be removed).

Additionally or alternatively, the advertisement server 111 may remove a node corresponding to a term which is present in more than a given number of lexical graphs. This approach may allow a cross-topic pruning by identifying terms that are present in multiple lexical graphs. Such terms will tend to be general terms that have less specific topic relevance and therefore is less likely to assist in selecting between content items. An exception to this may be for terms that are prevalent in one topic (e.g. high term frequency) but are insignificant in other topics (e.g. a low term frequency) and the pruning may be amended to take this into account.

Additionally or alternatively, the advertisement server 111 may remove a node corresponding to a first term from the first lexical graph in response to a detection that the first term belongs to an excluded subset of terms. Specifically, a set of excluded named entities (e.g. “Unit”) may be predefined and the advertisement server 111 may remove any node and associated edges for terms that belong to this set of excluded named entities. Alternatively or additionally, the advertisement server 111 may prune the lexical graph by removing one or more edges. Specifically, an edge may be removed if a co-occurrence value for the terms of the nodes which are connected by the edge is below a threshold.

For example, a lower threshold for the co-occurrence between two terms can be derived based on co-occurrence statistics from the graph. If the co-occurrence frequency between two terms is below that threshold (e.g. the average co-occurrence value), the edge between the terms is not included in the pruned graph. This pruning criterion is very effective in reducing the graph size, because there tends to often be many single co-occurrences that are circumstantial and do not indicate a strong relation between the terms.

Thus in the example, the operation of the system may include generating at least one lexical graph, the generating of the at least one lexical graph comprising the steps of: generating a set of terms comprising terms from a plurality of term sets for training content items; generating nodes for the at least one lexical graph corresponding to at least some terms of the set of terms; and generating edges for the at least one lexical graph in response to co-occurrences of the at least some terms within the plurality of terms sets for training content items.

In some examples, the operation may further comprise removing a node corresponding to a first term from the lexical graph in response to a detection that at least one of a term frequency value and a document frequency value for the first term is below a threshold.

In some examples, the operation may further comprise removing a node corresponding to a first term from the at least one lexical graph in response to a detection that the first term is present in more than a threshold number of lexical graphs.

In some examples, the operation may further comprise removing an edge from the at least one lexical graph in response to a detection that a co-occurrence value for terms of nodes connected by the edge are below a threshold.

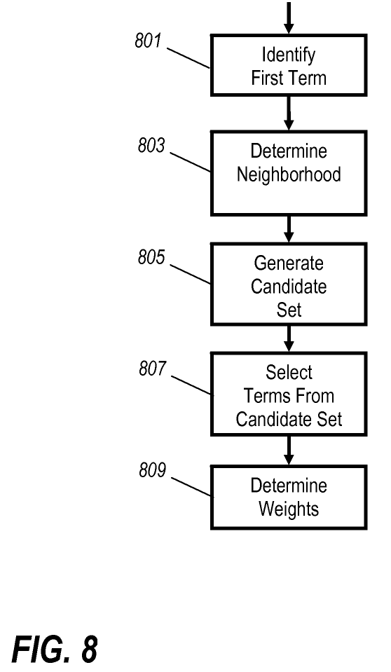

In the specific system, initial populated ontologies for a plurality of domains are generated by the advertisement server 111 and communicated to the content device 101. The method used by the ontology population processor 221 to populate each concept in the basic ontology is illustrated in FIG. 8. First, in step 801, the ontology population processor 221 proceeds to determine a first set of terms in the lexical graph that match a single concept in the ontology. This match is based on a match criterion which specifically can comprise a requirement that at least one term of the lexical graph matches the concept terminologically in order for this term to be included in the first term. Thus, a set of initial terms are identified in the graph where the initial terms correspond directly to a concept in the ontology. It will be appreciated that any suitable criterion for matching terms may be used. It will also be appreciated that in some embodiments the processing is performed sequentially and individually for each concept. Thus, the ontology population processor 221 may in some embodiments populate each individual concept separately. In the example, step 801 thus results in the ontology population processor 221 determining a subset of nodes of the selected lexical graph which have terms that are terminologically matching the concept which is being populated.

The nodes that are selected in step 801 may furthermore be selected as the nodes that are considered to correspond to terms which are particularly relevant or important for this concept. This importance or relevance may for example be reflected in the node value and/or the values of edges. The relevance may e.g. be determined by any suitable match criterion or algorithm. For example, stemming (stemming is the process of reducing inflected (or sometimes derived) words to their stem, base or root form), processing of web corpora or use of dictionaries to identify terms of the same meaning may be considered.

For example, the content device 101 may select the nodes for which the term frequency and the document frequency are above a given threshold. As another example, the content device may be arranged to select a fixed size subset of nodes. For example, the fifty nodes that match terms of the term vector and which have the highest term frequency may be selected. Alternatively or additionally, the nodes may be selected in response to a co-occurrence degree which is indicative of how many terms the node term co-occurs with. For example, the number of edges connected to the node may be determined and the content device 101 may proceed to only include the nodes for which this value is above a given threshold. A high number of edges tend to be indicative of the node term being highly significant for the given topic and accordingly this approach may allow the subset of nodes to be selected to correspond to terms that are important for the specific topic.

Step 801 is followed by step 803 wherein the ontology population processor 221 proceeds to determine a set of neighboring terms belonging to a graph neighborhood of the first term. The nodes that are selected in step 803 may furthermore be selected as the nodes that are considered to correspond to terms which are particularly relevant or important for this concept. This importance or relevance may for example be reflected in the node value and/or the values of edges. Thus, the initial subset of nodes is used to identify a neighbour set of nodes which includes nodes that meet a given neighborhood criterion for at least one of the nodes in the initial subset. A neighboring node may e.g. be considered to be a node that is connected to a node of the initial terms/nodes by an edge of the lexical graph. In some scenarios, the neighborhood nodes may include nodes connected to an initial node via one or more intervening nodes.

It will be appreciated that in some embodiments, the set of neighboring nodes may include all nodes that neighbors a node of the subset of initial nodes determined in step 801. However, this may result in many terms being included that may not be highly significant for the topic/concept. In the specific example the selection of nodes to include in the set of neighboring nodes is performed in response to at least one of a node value and an edge value for neighbor nodes.

Specifically, a node may only be included if at least one of a term frequency value, a document frequency value and a co-occurrence value for the node meets a criterion. The criterion may require that the value is above a threshold thereby resulting in nodes only being included if the terms have sufficient significance in the lexical graph. Alternatively or additionally, a neighboring node may only be included if it is sufficiently closely related to a term of the term vector. The selection may specifically require that an edge of the neighboring node to the node of the initial terms determined in step 801 has a value that exceeds a threshold. Thus, neighboring nodes may e.g. only be included if the co-occurrence value between the terms is above a given value.

In some embodiments, a neighborhood may include nodes that are connected via a plurality of edges and intervening nodes. In such case, the node/term may only be included if the combined edge value meets a criterion. For example, for the “Eating Out” graph of FIG. 5, the neighborhood of nodes for the node/term “Burger King” may be determined by first selecting all direct neighbors (i.e. connected to the term/node “Burger King” by a direct edge). This will identify the neighbors “Restaurant”, “Domino's” and “KFC”. For each of these terms/nodes, the co-occurrence value represented by the edge between them and the “Burger King” term/node may be evaluated and the terms for which this value is below a given threshold may be discarded. This may for example leave the neighbors “KFC” and “Restaurant”. The term frequency value and document frequency value for these terms/nodes may then be compared to thresholds and any terms/nodes that are below the threshold may be discarded. This may for example be the case for the term/node “Restaurant” thereby leaving only the term/ node “KFC” in the neighbor set.

The system may then in some embodiments proceed to evaluate the next layer of neighbors of the remaining terms/nodes. In the specific example, this will include the terms/ nodes “McDonalds” and “Restaurant”. The term/node “Restaurant” has already been discarded and will therefore be ignored. For the term/node “McDonalds”, the combined co-occurrence value represented by the edge between the term/node “Burger King” and the term/node “KFC” and the edge between the term/node “McDonalds” and the term/node “KFC” is determined, for example by multiplying the two individual edge values (each in the interval [0,1]). The combined co-occurrence value is compared to a threshold and the term/node is rejected if the value is below the threshold. Otherwise, the term frequency value and the document frequency value are compared to thresholds and the term/node is rejected if below the threshold. Thus, terms/nodes that are not direct neighbors of the term being expanded may be included if they are sufficiently important and sufficiently correlated with the term. Thus, in the example, the set of neighboring nodes may end up comprising the terms “KFC” and “McDonalds”. Thus, the approach has allowed the term “McDonalds” to be determined to be closely related to “Burger King” despite these not being direct neighbors.

Step 803 is followed by step 805 wherein a candidate set of terms comprising terms of the set of neighborhood terms of the initial term (representing a concept in the ontology) is generated. The candidate set may also include the initial terms determined in step 801. Thus, a candidate set of terms is generated which includes all the terms of the graph that are considered to match the concept, as well as the terms of the corresponding neighborhood nodes, i.e. the terms which meet a given neighborhood criterion indicating that they are closely related to the initial terms. Step 805 is followed by step 807 wherein the ontology population processor 221 selects terms for the term vector for the concept from the candidate set. Thus, a selection of the identified terms is performed and the selected terms are added to the term vector to provide an expanded characterization of the concept. This expanded term vector characterization may improve the translation from non-homogenous characterizing term sets to the common concept based interlingua. In particular, it may provide an improved translation as the ontology may have an enlarged vocabulary for the translation.

In some embodiments, all the identified terms are simply selected and added to the term vector. However, typically a more advanced selection is performed to select terms that are particularly likely to be of relevance for the concept. This may ensure that the term vectors and thus the ontology is kept relatively small and may prevent characterizations of concepts by term vectors becoming too non-specific.

As a specific example, the ontology population processor 221 may first determine edge connections in the lexical graph that are between two nodes which correspond to terms that are both present in the term vector. Thus, in step 807 the ontology expansion processor 221 first determines how many edges there are for each node of the candidate term set which connect to another node of the candidate term set. Specifically, the candidate term set may be sorted based on how often the terms of the expanded term set co-occur with each other.

The content device 101 may then proceed to select the terms of the neighboring nodes that are included in the candidate set of terms depending on these edge connections. For example, only a fixed number of expansion terms may be included and these may be selected from the terms of the candidate set as the ones having the highest number of co-occurrences with other terms of the candidate term set. Such an approach may result in a more consistent expansion and a selection of terms that are particularly significant for the specific concept.

Step 807 is followed by step 809 wherein the ontology population processor 221 proceeds to determine weights for the additional terms that are added to the term vector. The weight may specifically be determined to reflect how close the new term is to an initial term matching an existing term in the term vector. Thus, the weight may be calculated as a function of a node value and/or an edge value of the term that is being included. Specifically, an edge value between the selected term and the initial term may be determined and used to calculate a suitable weight. For example, the higher the co-occurrence is between the selected term and the initial term, the higher the likelihood of the terms both being relevant for the concept and thus the higher the weight. It will be appreciated that weight determination may be further enhanced by co-examining the neighborhoods of all the initial terms of the considered concept to determine a unified weight for neighborhood terms that may be related to more than one initial terms.

The process of FIG. 8 may then be iterated for all concepts of the ontology. Thus, based on the lexical graph, the term vectors are expanded to provide a more detailed and flexible indication of terms that are relevant to the concept. This expansion may be performed automatically and based on real data and thus is not limited by or require manual definition. The approach may specifically provide term vectors that allow an even more appropriate translation from non-homogenous term vectors into a common generic concept based characterization. Furthermore, flexibility is enhanced by this process generating weights that reflect the probability of the individual terms of the term vector being relevant for the concept. This may provide an improved and more flexible translation of term sets into concept sets.

It will be appreciated that whereas the above description has focused on an example where the domain concept enrichment based on the lexical graphs is performed in the content device, it may in other embodiments be performed elsewhere. For example, in many embodiments, the population of the ontology is performed remotely from the content device and is furthermore performed centrally for a plurality of content devices 101. For example, the advertisement server 111 may obtain the original basic ontology and then populate this based on lexical graphs that have been generated by the advertisement server 111 from a training set. The resulting ontology may then be communicated to all content devices 103.

Thus, specifically, the functionality described with reference to the ontology processor 207 may all be performed in the advertisement server 111. The content device 103 may then simply receive the populated ontology and feed this to the concept processor 209. Such an approach may allow a particularly efficient system where the communication resource and computational resource of the content devices 103 may be maintained low. Indeed, the populated ontology is a particularly efficient data structure to distribute between content devices 103.

In some embodiments, the content device 101 may be arranged to modify one or more of the lexical graphs in response to characteristics of the content items that are selected by the user. For example, when a user selects a specific content item, the characterizing data for this content item (e.g. the associated metadata or text extracted from a text content item) may be correlated with the terms of a lexical graph and used to update the graph. The modification may for example add or remove nodes to the lexical graph and/or may for example modify a node value or an edge value of the graph.

Thus, in the system, generic lexical graphs for a plurality of topics may initially be downloaded from the advertisement server 111 at the initialization of the service. Thus, initially a default set of lexical graphs constructed by the advertisement server 111 is communicated to new content devices subscribing to the service. However, based on e.g. metadata extracted from the consumed content, the content device 101 can update the graph structure so that, with time, each content device 101 will have an individual set of graphs that better reflect the user's personal interests and preferences, or that better reflect the topic.

The lexical graphs stored in the content device 101 may e.g. be updated each time new content is consumed by the user. The update process may specifically be similar to the process employed during the default graph construction by the advert server 111. Thus, the term frequency or document frequency may be increased whenever a term of the lexical graph is detected in a selected content item. Similarly, a co-occurrence between two terms may also be detected and used to increase an edge value for an edge connecting the two nodes corresponding to these two terms. Furthermore, at regular intervals new statistics may be calculated for the graph and used to prune the graph. E.g. the term frequencies may change with time and may result in a term frequency falling below a given threshold resulting in the corresponding node being removed. Also, if a new term is detected, this may be added to the lexical graph.

In order to increase the initial speed of adaptation, the modification value which is applied to a node value or an edge value may be decreasing with time such that it initially is substantially stronger. E.g. a temporarily decaying factor can be used when updating a term frequency, document frequency or co-occurrence value. Denoting the value being modified by d, the modification may for example be given as:

d_{new}=(1+α·e^{-(t-t}^{₀}⁾)·d_{old}

where t is the time of content consumption and t₀ is a zero time-point (e.g. the time when the default lexical graph was received). α is a design constant that can be set to result in the desired update speed.

It will be appreciated that the modification and user adaptation of the lexical graphs may result in substantially improved term set expansion and thus advert selection. In particular, the personalization of the lexical graphs may provide a highly efficient and low complexity means for selecting adverts that match both the currently selected content item as well as the user's general preferences.

Furthermore, in some embodiments, the user profiles stored in the content device 101 may be updated each time new content is consumed by the user, e.g. using a similar approach as previously described for updating lexical graphs. The update process may specifically be similar to the process employed during the default user profile construction by the advertisement server 111. Thus, the preference weights of concepts derived from the translation performed in the concept processor 209 may be increased whenever a concept is detected in a selected content item. Similarly, a co-occurrence between two concepts may also be detected and used to determine a relation between the concepts. Furthermore, at regular intervals new statistics may be calculated for the profile and used to prune the profile. E.g. the preference weights may change with time and may result in a preference weight falling below a given threshold resulting in the corresponding preference being removed. Also, if a new preference is detected, this may be added to the user profile.

In order to increase the initial speed of adaptation, the modification value which is applied to a preference value may be decreasing with time such that it initially is substantially stronger. E.g. a temporarily decaying factor can be used when updating a user preference value. Denoting the value being modified by d, the modification may for example be given as:

d_{new}=(1+α·e^{(t t}^{₀}⁾)·d_{old}

where t is the time of content consumption and t₀ is a zero time-point (e.g. the time when the previous profile representation was received). α is a design constant that can be set to result in the desired update speed.

It will be appreciated that the modification and analysis of user preferences may result in substantially improved term set expansion and thus advertisement selection. In particular, user information may be reflected back to the user profile and provide a highly efficient and low complexity means for selecting advertisements that match both the currently selected content item as well as the user's general preferences.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A method of generating recommendations for content items, the method comprising:
providing a domain ontology comprising a plurality of interrelated concepts, each concept of the plurality of interrelated concepts being represented by a term vector comprising at least one term and an associated weight for each term;
providing a plurality of associated term sets, each associated term set of the plurality of associated term sets comprising a set of terms characterizing a content item of a group of content items;
generating a plurality of associated concept sets for the group of content items by determining for each of at least some of the plurality of associated term sets a set of concepts comprising concepts of the domain ontology matching terms of the associated term set;
providing a user profile for a user, the user profile comprising user preference weights associated with at least some concepts of the domain ontology;
generating recommendations for at least one content item from the group of content items in response to the plurality of associated concept sets and the user profile.

2. The method of claim 1 wherein the step of generating the plurality of associated concept sets comprises:
including a first concept in a first associated concept set for a first content item in response to a detection of a first term of a first term vector for the first concept matching a term of a first associated term set for the first content item.

3. The method of claim 3 wherein the inclusion of the first concept in the first associated concept set is further in response to an associated weight of the first term in the first term vector.

4. The method of claim 1 wherein the associated weight for a first term of a first term vector for a first concept of the domain ontology is indicative of a probability of the first term being relevant for characterizing the first concept.

5. The method of claim 1 further comprising
providing a lexical graph, the lexical graph comprising nodes corresponding to terms and edges corresponding to a relationship between terms of nodes connected by the edge; and
adding terms to term vectors of the domain ontology based on the lexical graph.

6. The method of claim 5 further comprising for at least a first concept of the domain ontology performing the steps of:
identifying a first set of terms in the lexical graph matching the first concept;
for at least a first term of the first set of terms determining a neighbor set of terms belonging to a graph neighborhood of the first term;
generating a candidate set of terms comprising terms of the set of neighborhood terms; and
selecting terms for a first term vector for the first concept from the candidate set.

7. The method of claim 6 further comprising determining a weight for a selected term from the candidate set in response to at least one of a node value and an edge value for the selected term in the lexical graph.

8. The method of claim 6 further comprising determining a weight for a selected term from the candidate set in response to an edge value for an edge included in a connection between the selected term and the first term in the lexical graph.

9. The method of claim 6 wherein selecting the neighbor set of terms comprises further selecting the neighbor set of terms in response to at least one of a node value and an edge value.

10. The method of claim 9 wherein selecting the neighbor set of terms comprises selecting only terms having a connection to the first term for which a combined edge value of edges of the connection meet a criterion.

11. The method of claim 6 wherein a match criterion for identifying the first set of terms comprises a requirement for at least one term of the first term to match a term for that term to be included in the first set of terms.

12. The method of claim 5 wherein edges between nodes have a value indicative of a strength of association between terms of the nodes.

13. The method of claim 5 wherein edges between nodes have a value indicative of a co-occurrence frequency for terms of the nodes.

14. The method of claim 5 further comprising updating the lexical graph in response to term vectors characterizing content items consumed by the user.

15. The method of claim 1 wherein the step of determining recommendations comprises applying a rule based reasoning algorithm to the plurality of associated concept sets and the user profile.

16. The method of claim 15 wherein the rule based reasoning algorithm is a fuzzy logic rule based reasoning algorithm.

17. The method of claim 1 further comprising:
monitoring consumption of content items by the user;
providing a content item term set characterizing a first content item consumed by the user;
determining a first concept of the user profile for which a term vector comprises at least a first term matching at least one term of the content item term set; and
modifying a preference weight for the first concept.

18. The method of claim 17 further comprising:
monitoring consumption of content items by the user;
providing a content item term set characterizing a first content item consumed by the user;
determining a first concept of the ontology having a term vector comprising at least a first term matching at least one term of the content item term set; and
modifying an associated weight for the first term.

19. A computer program product comprising instructions which, when run on a computer, will cause said computer to perform the method of claim 17.

20. A system for generating recommendations for content items, the system comprising:
a unit for providing a domain ontology comprising a plurality of interrelated concepts, each concept of the plurality of interrelated concepts being represented by a term vector comprising at least one term and an associated weight for each term;
a unit for providing a plurality of associated term sets, each associated term set of the plurality of associated term sets comprising a set of terms characterizing a content item of a group of content items;
a unit for generating a plurality of associated concept sets for the group of content items by determining for each of at least some of the plurality of associated term sets a set of concepts comprising concepts of the domain ontology matching terms of the associated term set;
a unit for providing a user profile for a user, the user profile comprising user preference weights associated with at least some concepts of the domain ontology; and
a unit for generating recommendations for at least one content item from the group of content items in response to the plurality of associated concept sets and the user profile.
